(19) United States
(12) Patent Application Publication
(10) Pub. No.: US 2018/0334089 A1
(43) Pub. Date: Nov. 22, 2018

(54) DRIVING INTENTION INDICATING DEVICE AND METHOD

(71) Applicants: Shanghai XPT Technology Limited, Shanghai City (CN); INTELLIGENCE & PARTNER LIMITED, Hong Kong (HK)

(72) Inventors: Mu-Jen Huang, Taipei City (TW); Ya-Li Tai, Taoyuan City (TW); Yu-Sian Jiang, Kaohsiung City (TW)

(21) Appl. No.: 15/721,704

(22) Filed: Sep. 29, 2017

(30) Foreign Application Priority Data
May 17, 2017 (CN) 201710350968.0
May 17, 2017 (CN) 201720548349.8

(51) Int. Cl. B60Q 1/34; B60Q 1/52; B60Q 1/50; B60Q 1/46

(52) U.S. Cl. CPC B60Q 1/346; B60Q 1/525; G01S 2013/9314; B60Q 1/46; B60Q 1/503

(57) ABSTRACT

A driving intention indicating device includes a projection system and a control unit. The projection system is arranged on a vehicle. The control unit is configured to control the projection system according to a change in a gear position of a gearbox of the vehicle. When the gear position of the gearbox of the vehicle is switched from a first gear position to a second gear position, the control unit is configured to control the projection system to project an indicating image on a road surface close the vehicle according to a moving direction of the second gear position, in order to indicate a moving direction of the vehicle from a parked position.

### BACKGROUND OF THE INVENTION

### 1. Field of the Invention

The present invention relates to a driving intention indicating device and method, and more particularly, to a driving intention indicating device and method capable of indicating a driving intention to surrounding people and other drivers.

### 2. Description of the Prior Art

A motor vehicle has lights configured to notify surrounding people and other drivers when the vehicle is reversing or turning. When the vehicle starts to move from a parked position, the resultant signal light from the parked vehicle is not very noticeable. Accidents between the vehicle and surrounding people or other vehicles may occur as a result. Moreover, when the turn signal of the vehicle is on, it may be unclear whether the vehicle is about to turn or change lanes. In the prior art, the signal lights of the vehicle are not able to clearly indicate a driver's intention to surrounding people and other drivers, such that the risk of traffic accidents may increase.

### SUMMARY OF THE INVENTION

An objective of the present invention is therefore to provide a driving intention indicating device and a driving intention indicating method to solve the problem of the prior art.

According to an embodiment of the present invention, a driving intention indicating device comprises a projection system and a control unit. The projection system is arranged on a vehicle. The control unit is configured to control the projection system according to a change in a gear position of a gearbox of the vehicle. wherein when the gear position of the gearbox is switched from a first gear position to a second gear position, the control unit is configured to control the projection system to project an indicating image on a road surface close to the vehicle according to a moving direction of the second gear position, in order to indicate a moving direction of the vehicle from a parked position.

According to another embodiment of the present invention, a driving intention indicating method comprises providing a projection system arranged on a vehicle. A change in a gear position of a gearbox of the vehicle is detected. When the gear position of the gearbox is switched from a first gear position to a second gear position, the projection system is controlled to project an indicating image on a road surface close to the vehicle according to a moving direction of the second gear position, in order to indicate a moving direction of the vehicle from a parked position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a first embodiment of a driving intention indicating device of the present invention.

FIG. 2 is a diagram showing the driving intention indicating device of the present invention projecting an indicating image on a road surface in front of a vehicle.

FIG. 3 is a diagram showing the driving intention indicating device of the present invention projecting a warning image on a road surface in front of the vehicle.

FIG. 4 is a diagram showing the driving intention indicating device of the present invention projecting an indicating image on a road surface at the rear of the vehicle.

FIG. 5 is a diagram showing a second embodiment of the driving intention indicating device of the present invention.

FIG. 6 is a diagram showing the driving intention indicating device of the present invention projecting a turn indicating image on a road surface close to the right side of the vehicle.

FIG. 7 is a diagram showing the driving intention indicating device of the present invention projecting a lane change indicating image on a road surface close to the right side of the vehicle.

FIG. 8 is a diagram showing the driving intention indicating device of the present invention projecting a warning image on a road surface close to the right side of the vehicle.

FIG. 9 is a flowchart showing a driving intention indicating method of the present invention.

### DETAILED DESCRIPTION

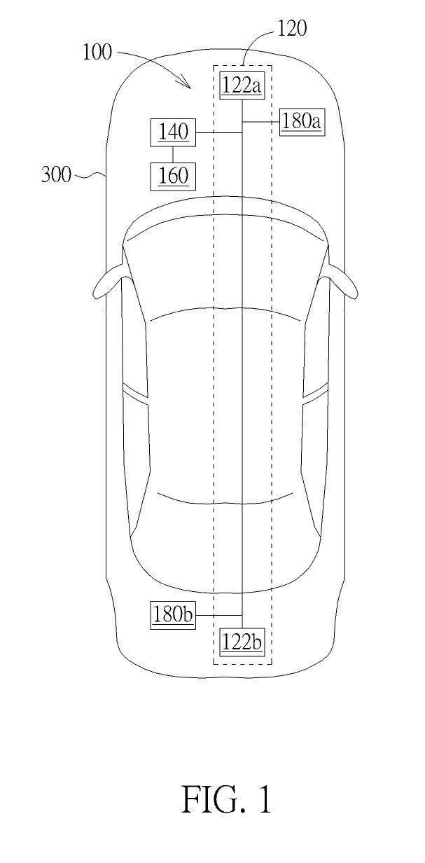

Refer to FIG. 1, which is a diagram showing a first embodiment of a driving intention indicating device of the present invention. As shown in FIG. 1, a driving intention indicating device 100 of the present invention is arranged on a vehicle 300. The driving intention indicating device 100 comprises a projection system 120 and a control unit 140. The projection system 120 is able to comprise a plurality of projection devices. In the present embodiment, the projection system 120 comprises two projection devices 122a, 122b respectively arranged on a front portion and a rear portion of the vehicle 300, but the present invention is not limited thereto. The control unit 140 is configured to control the projection system 120 according to a change in a gear position of a gearbox of the vehicle 300. For example, when the gear position of the gearbox of the vehicle 300 is switched from a first gear position to a second gear position (such as a drive gear position or a reverse gear position), the control unit 140 is configured to control the projection system 120 to project an indicating image on a road surface close to the vehicle according to a moving direction of the second gear position, in order to indicate the moving direction of the vehicle 300 from a parked position.

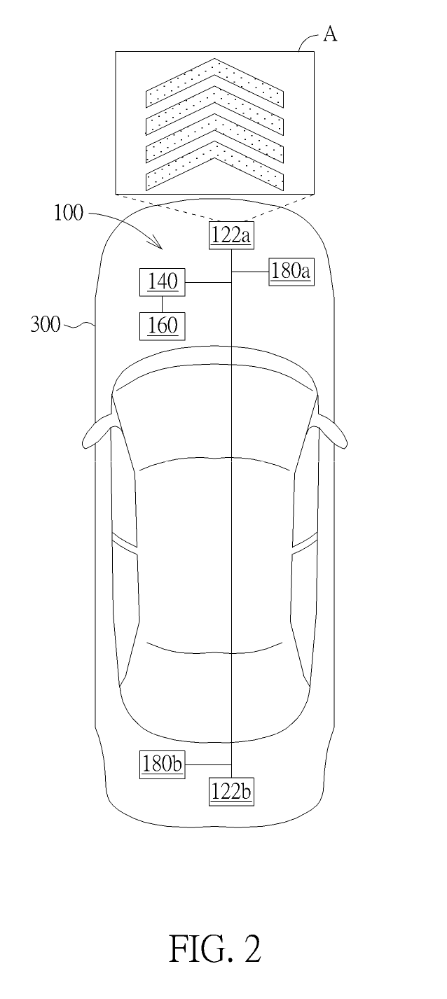

Refer to FIG. 2. FIG. 2 is a diagram showing the driving intention indicating device of the present invention projecting an indicating image on a road surface in front of a vehicle. As shown in FIG. 2, when a driver of the vehicle 300 switches the gear position of the gearbox of the vehicle 300 from a park gear position (or a reverse gear position, or a neutral gear position) to a drive gear position, the control unit 140 is configured to control the projection system 120 to project an indicating image A on a road surface in front of the vehicle 300 according to the change of the gear position of the gearbox of the vehicle 300, in order to notify surrounding people and other drivers that the status of the vehicle 300 is switched from a parking status to a moving status. In the present embodiment, the indicating image A is a symbol showing the vehicle moving ahead, but the present invention is not limited thereto. The indicating image A can comprise a symbol, a film and/or a text.

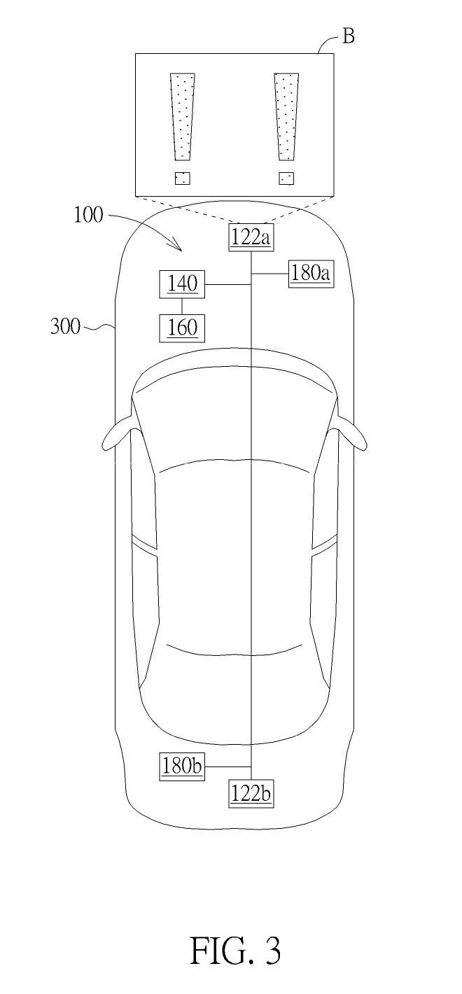

In addition, the driving intention indicating device 100 is able to further comprise at least one sensor. In the present embodiment, the driving intention indicating device 100 comprises two sensors 180a, 180b respectively arranged on a front portion and a rear portion of the vehicle 300, but the present invention is not limited thereto. The sensors 180a, 180b are configured to sense objects located in an edge of the indicating image on the road surface projected by the projection system 120. When an object is sensed in the edge of the indicating image by the sensors 180a, 180b, the control unit 140 is configured to generate a warning signal outside of the vehicle 300. For an illustration of this, refer to FIG. 2 and FIG. 3. FIG. 3 is a diagram showing the driving intention indicating device of the present invention projecting a warning image on a road surface in front of the vehicle. As shown in FIG. 3, when the sensor 180a senses an object (such as a passer-by or a car) located in the edge of the indicating image A, the control unit 140 is configured to control the projection system 120 to project a warning image B on a road surface in front of the vehicle, in order to warn surrounding people and other drivers to give way the vehicle 300. In the present embodiment, the warning image B is a warning symbol, but the present invention is not limited thereto. The warning image B can comprise a flashing image, a warning symbol and/or a warning text.

The driving intention indicating device 100 of the present invention is able to further comprise a speaker 160. When an object is sensed in the edge of the indicating image A by the sensors 180a, 180b, the control unit 140 is configured to control the speaker 160 to generate a warning voice outside of the vehicle 300, in order to warn surrounding people and other drivers to give way the vehicle 300 to prevent traffic accidents.

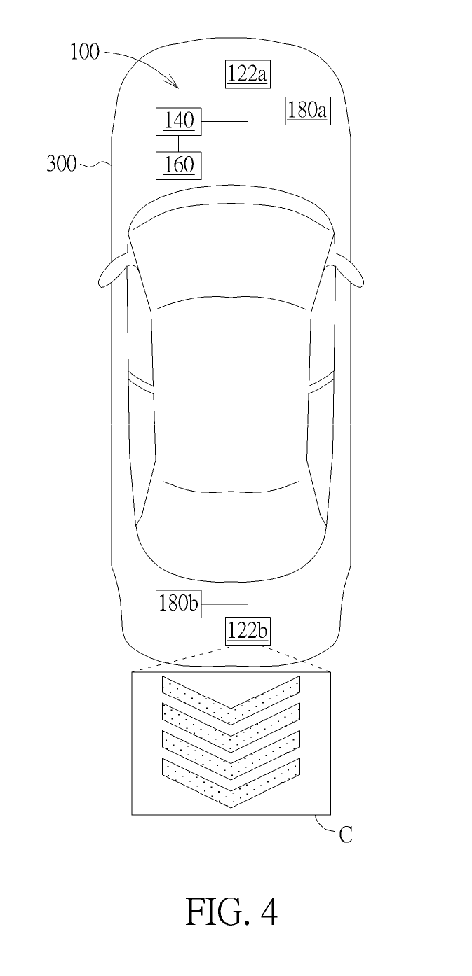

Refer to FIG. 4. FIG. 4 is a diagram showing the driving intention indicating device of the present invention projecting an indicating image on a road surface at the rear of the vehicle. As shown in FIG. 4, when the driver of the vehicle 300 switches the gear position of the gearbox of the vehicle 300 from the park gear position (or the drive gear position, or the neutral gear position) to the reverse gear position, the control unit 140 is configured to control the projection system 120 to project an indicating image C on a road surface at the rear of the vehicle 300 according to the change in gear position, in order to notify surrounding people and other drivers that the status of the vehicle 300 is switched from the parking status to a reversing status. The indicating image C can comprise a symbol, a film and/or a text. In addition, when an object is sensed in the edge of the indicating image C by the sensors 180a, 180b, the control unit 140 is also configured to generate a warning signal (such as a warning image and/or a warning voice) outside of the vehicle 300. The arrangement of generating the warning signal is similar to the above arrangement. For simplification, no further illustration is provided.

According to the above arrangement, when the status of the vehicle 300 is switched from the parking status to the moving status, the control unit 140 is configured to control the projection system 120 to project an indicating image on a road surface nearby the vehicle 300, in order to clearly indicate the intention of the driver of the vehicle 300 to surrounding people and other drivers through symbols, films and/or texts in the indicating image. In addition, the driving intention indicating device 100 is configured to sense objects located in an edge of the indicating image on the road surface by the sensors 180a, 180b. When passers-by and cars are sensed in the edge of the indicating image, the driving intention indicating device 100 is also configured to generate a warning image and/or a warning voice outside of the vehicle 300, in order to prevent traffic accidents.

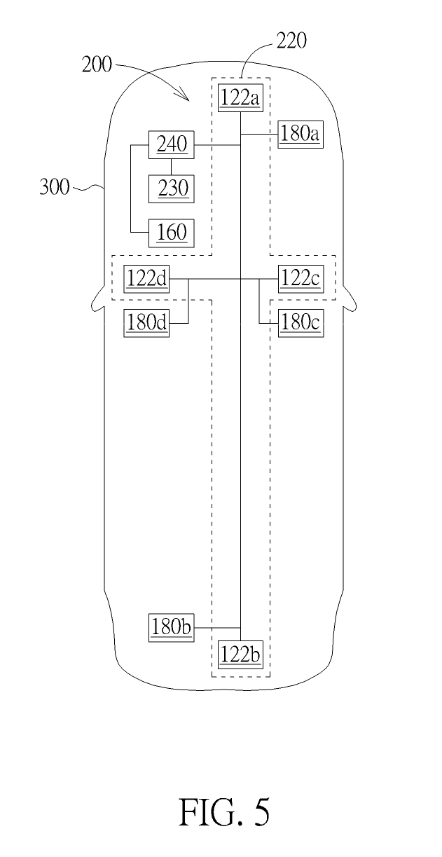

Refer to FIG. 5. FIG. 5 is a diagram showing a second embodiment of the driving intention indicating device of the present invention. As shown in FIG. 5, the second embodiment of the driving intention indicating device 200 of the present invention comprises a projection system 220, an input device 230 and a control unit 240. In the present embodiment, the projection system 220 comprises four projection devices 122a, 122b, 122c and 122d respectively arranged on a front portion, a rear portion, a right side and a left side of the vehicle 300, but the present invention is not limited thereto. Similarly, the control unit 240 of the driving intention indicating device 200 of the present invention is configured to control the projection devices 122a, 122b according to a change in a gear position of a gearbox of the vehicle 300. The arrangement of the control unit 240 and the projection devices 122a, 122b for generating the indicating image (or the warning signal) in front of the vehicle (or at the rear of the vehicle) is similar to the first embodiment. For simplification, no further illustration is provided. In the present embodiment, the control unit 240 is also configured to control the projection devices 122c, 122d to project a turn indicating image or a lane change indicating image on a road surface according to a turning instruction or a lane changing instruction. The input device 230 is electrically connected to the control unit 240. The input device 230 is configured to generate the turning instruction or the lane changing instruction according to an input from the driver of the vehicle 300. For example, the input device 230 is configured to generate the turning instruction or the lane changing instruction according to a gesture input, a voice input or a touch input from the driver of the vehicle 300. In addition, the input device 230 can also be electrically connected to a component (such as a turn signal lever) of the vehicle 300 or electrically connected to a button, in order to generate the turning instruction or the lane changing instruction according to a trigger signal of the turn signal lights and/or a trigger signal of the button.

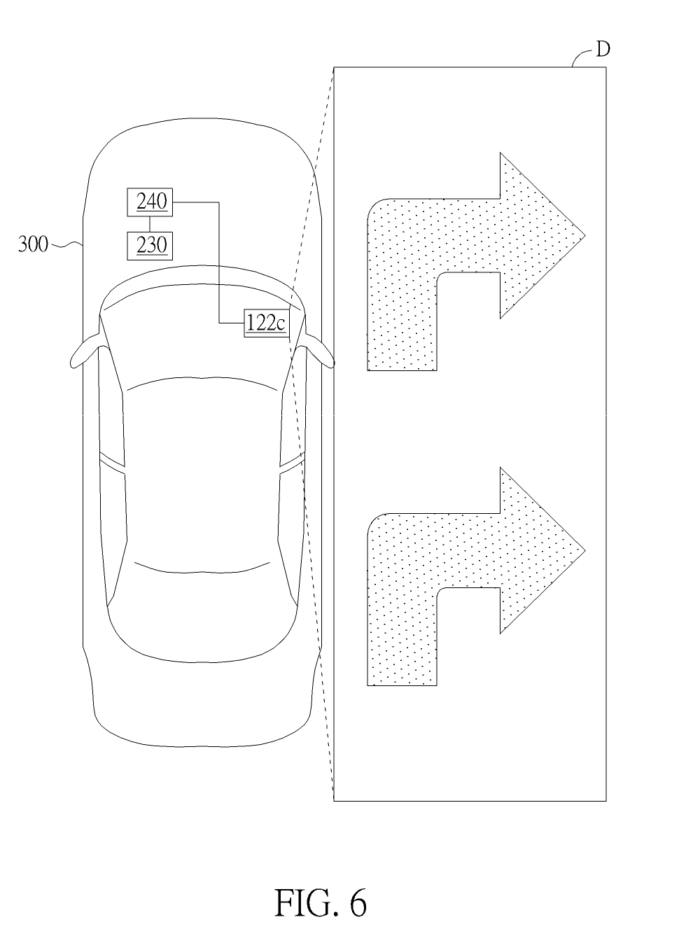

For an illustration of the above, refer to FIG. 6. FIG. 6 is a diagram showing the driving intention indicating device of the present invention projecting a turn indicating image on a road surface close to the right side of the vehicle 300. For simplification, some components of the driving intention indicating device 200 are omitted in FIG. 6. As shown in FIG. 6, when the control unit 240 receives a turning instruction of a right turn, the control unit 240 is configured to control the projection device 122c to project a turn indicating image D on a road surface close to the right side of the vehicle 300 according to the turning instruction to indicate a turning direction of the vehicle 300, such that other drivers nearby are notified that the vehicle 300 is going to turn right. In the present embodiment, the turn indicating image D is an arrow symbol showing the vehicle 300 is turning right, but the present invention is not limited thereto. The turn indicating image D can comprise a turning symbol, a turning arrow film and/or a turn indicating text.

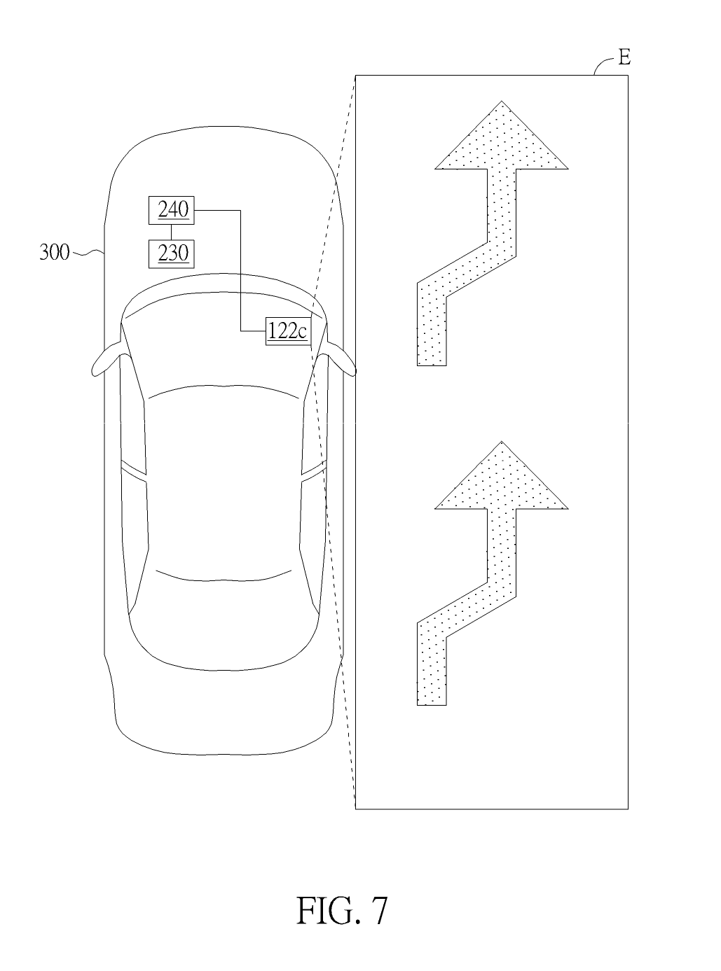

Refer to FIG. 7. FIG. 7 is a diagram showing the driving intention indicating device of the present invention projecting a lane change indicating image on a road surface close to the right side of the vehicle. For simplification, some components of the driving intention indicating device 200 are omitted in FIG. 7. As shown in FIG. 7, when the control unit 240 receives a lane changing instruction of changing to a right lane, the control unit 240 is configured to control the projection device 122c to project a lane change indicating image E on a road surface close to the right side of the vehicle 300 according to the lane changing instruction to indicate a lane changing direction of the vehicle 300, such that other drivers nearby are notified that the vehicle 300 is going to change to the right lane. In the present embodiment, the lane change indicating image E is an arrow symbol showing the vehicle 300 is changing to the right lane, but the present invention is not limited thereto. The lane change indicating image E can comprise a lane changing symbol, a lane changing arrow film and/or a lane changing indicating text.

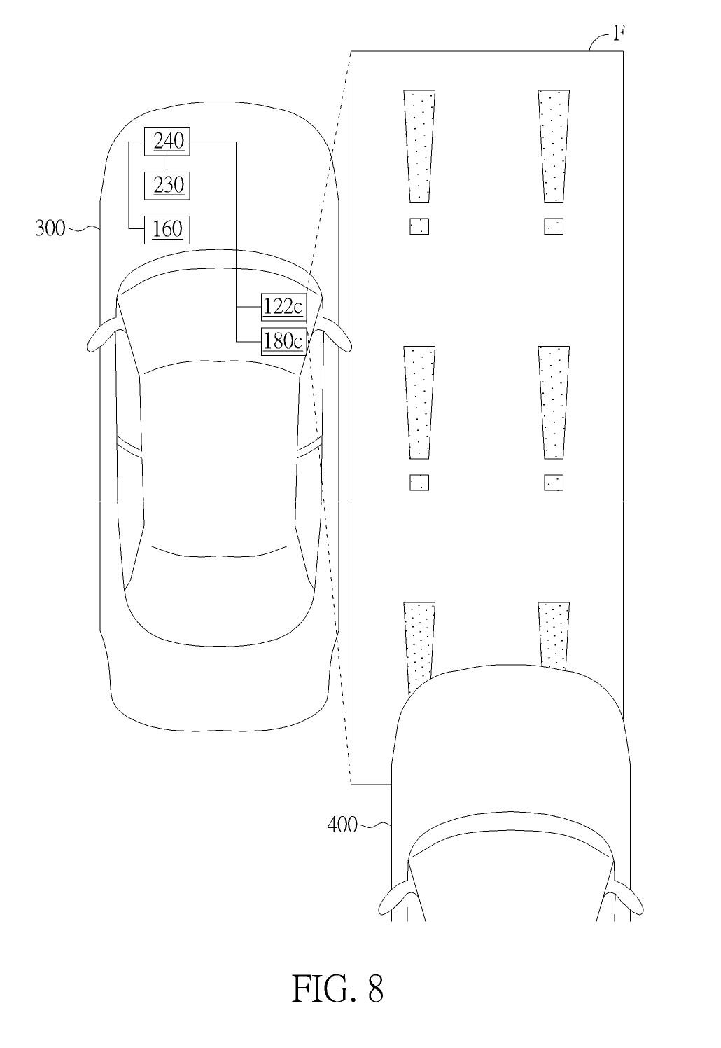

The driving intention indicating device 200 can further comprise two sensors 180c and 180d respectively arranged on a ride side and a left side of the vehicle 300. The sensor 180c and 180d are configured to sense objects in a blind area of the vehicle 300. When a vehicle is sensed in the blind area of the vehicle 300 when the vehicle 300 is turning or changing lanes, the control unit 240 is configured to control the projection system 220 to project a warning image to warn the driver of the vehicle in the blind area of the vehicle 300. For an illustration of this, refer to FIG. 8. FIG. 8 is a diagram showing the driving intention indicating device of the present invention projecting a warning image on a road surface close to the right side of the vehicle. For simplification, some components of the driving intention indicating device 200 are omitted in FIG. 8. As shown in FIG. 8, when the control unit 240 receives a turning instruction of a right turn or a lane changing instruction of changing to a right lane and a vehicle 400 is sensed in the blind area of the vehicle 300 by the sensor 180c, the control unit 240 is configured to control the projection device 122c to project a warning image F on a road surface close to the right side of the vehicle 300, in order to warn the driver of the vehicle 400 to give way to the vehicle 300 to prevent accidents. In addition, the control unit 240 is also configured to control the speaker 160 to generate a warning voice outside of the vehicle 300. In the present embodiment, the warning image F is a warning symbol, but the present invention is not limited thereto. The warning image F can comprise a flashing image, a warning symbol and/or a warning text.

According to the above arrangement, when the control unit 240 of the driving intention indicating device 200 receives the turning instruction or lane changing instruction, the control unit 240 is configured to control the projection system 220 to project the turn indicating image or lane change indicating image on the road surface close to the vehicle 300 to clearly indicate the intention of turning or changing lanes of the driver of the vehicle 300. The driving intention indicating device 200 of the present invention is also configured to sense other vehicles in the blind area via the sensors 180c and 180d. When the control unit 240 receives the turning instruction or lane changing instruction and a vehicle is sensed in the blind area, the driving intention indicating device 200 is configured to generate a warning image or a warning voice outside of the vehicle 300 to prevent traffic accidents.

In the above embodiment, the projection device can be a laser projection device or other projection device; the sensor can be an image sensor or radar; and the input device can comprise a touch input device, image detector and/or a microphone, but the present invention is not limited thereto.

In addition, the driving intention indicating device can also be applicable to a vehicle with an automatic driving function. When a computer of the vehicle with the automatic driving function controls the vehicle to move, the driving intention indicating device can also project an indicating image to indicate driving intentions of the computer of the vehicle, and generate a warning signal to warn surrounding people and other drivers to give way the vehicle to prevent traffic accidents.

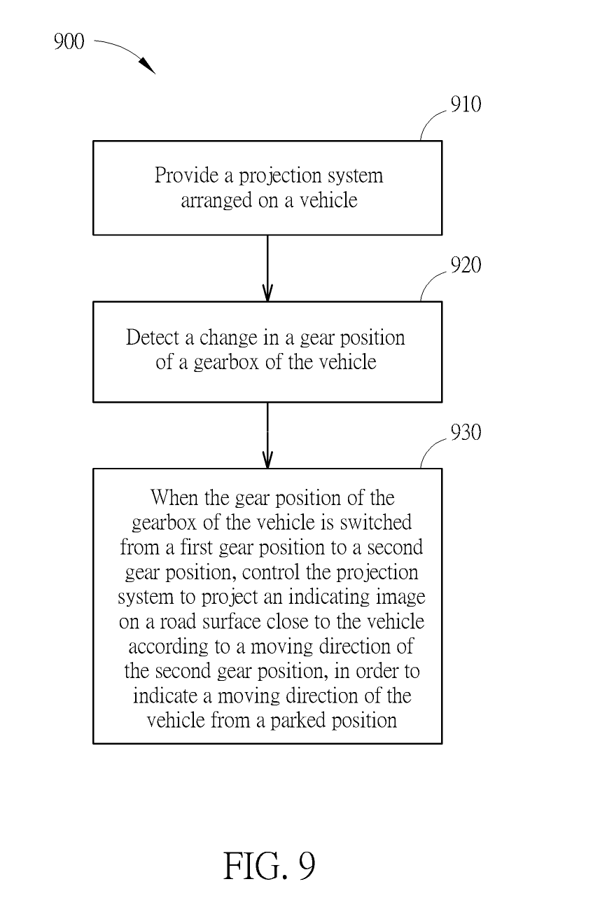

Refer to FIG. 9. FIG. 9 is a flowchart 900 showing a driving intention indicating method of the present invention. The driving intention indicating method of the present invention comprises the following steps:

Step 910: Provide a projection system arranged on a vehicle;

Step 920: Detect a change in a gear position of a gearbox of the vehicle; and

Step 930: When the gear position of the gearbox of the vehicle is switched from a first gear position to a second gear position, control the projection system to project an indicating image on a road surface close to the vehicle according to a moving direction of the second gear position, in order to indicate a moving direction of the vehicle from a parked position.

In contrast to the prior art, the driving intention indicating device of the present invention is configured to project the indicating image to notify surrounding people and other drivers of the intention of the driver according to the changed gear position, the turning instruction or the lane changing instruction. Moreover, the driving intention indicating device of the present invention is configured to generate the warning image and/or the warning voice when an object is sensed in an edge of the indicating image (or warning image) on the road surface. Furthermore, when the vehicle is going to turn or change lanes, the driving intention indicating device of the present invention is configured to warn drivers of other vehicles in the blind area, in order to prevent accidents. Therefore, the driving intention indicating device of the present invention is capable of reducing the risk of traffic accidents and improving traffic safety.

Those skilled in the art will readily observe that numerous modifications and alterations of the device and method may be made while retaining the teachings of the invention. Accordingly, the above disclosure should be construed as limited only by the metes and bounds of the appended claims.

1. A driving intention indicating device, comprising:
a projection system arranged on a vehicle; and
a control unit configured to control the projection system according to a change in a gear position of a gearbox of the vehicle;
wherein when the gear position of the gearbox of the vehicle is switched from a first gear position to a second gear position, the control unit is configured to control the projection system to project an indicating image on a road surface close to the vehicle according to a moving direction of the second gear position, in order to indicate a moving direction of the vehicle from a parked position.

2. The driving intention indicating device of claim 1, wherein the second gear position is a drive gear position, and the control unit is configured to control the projection system to project the indicating image on a road surface in front of the vehicle.

3. The driving intention indicating device of claim 1, wherein the second gear position is a reverse gear position, and the control unit is configured to control the projection system to project the indicating image on a road surface at the rear of the vehicle.

4. The driving intention indicating device of claim 1, further comprising:
a sensor configured to sense objects located in an edge of the indicating image on the road surface projected by the projection system;
wherein when an object is sensed by the sensor, the control unit is configured to generate a warning signal outside of the vehicle.

5. The driving intention indicating device of claim 4, wherein when an object is sensed by the sensor, the control unit is configured to control the projection system to project a warning image on a road surface close to the vehicle, wherein the warning image comprises at least one of a flashing image, a warning symbol and a warning text.

6. The driving intention indicating device of claim 4, wherein when an object is sensed by the sensor, the control unit is configured to control a speaker to generate a warning voice outside of the vehicle.

7. The driving intention indicating device of claim 1, wherein the control unit is further configured to control the projection system to project a turn indicating image on a road surface close to a side of a turning direction of the vehicle according to a turning instruction.

8. The driving intention indicating device of claim 7, wherein the turn indicating image comprises at least one of a turning symbol, a turning arrow film and a turn indicating text.

9. The driving intention indicating device of claim 7, wherein the turning instruction is generated by at least one of a gesture input, a voice input, a touch input, a trigger signal of the turn signal lights and a trigger signal of a button.

10. The driving intention indicating device of claim 1, wherein the control unit is further configured to control the projection system to project a lane change indicating image on a road surface close to a side of a changing lane direction of the vehicle according to a lane changing instruction.

11. The driving intention indicating device of claim 10, wherein the lane change indicating image comprises at least one of a lane changing symbol, a lane changing arrow film and a lane changing indicating text.

12. The driving intention indicating device of claim 10, wherein the lane changing instruction is generated by at least one of a gesture input, a voice input, a touch input, a trigger signal of the turn signal lights and a trigger signal of a button.

13. A driving intention indicating method, comprising:
providing a projection system arranged on a vehicle;
detecting a change in a gear position of a gearbox of the vehicle; and
when the gear position of the gearbox of the vehicle is switched from a first gear position to a second gear position, controlling the projection system to project an indicating image on a road surface close to the vehicle according to a moving direction of the second gear position, in order to indicate a moving direction of the vehicle from a parked position.

14. The driving intention indicating method of claim 13, wherein when the second gear position is a drive gear position, controlling the projection system to project the indicating image on a road surface in front of the vehicle.

15. The driving intention indicating method of claim 13, wherein when the second gear position is a reverse gear position, controlling the projection system to project the indicating image on a road surface at the rear of the vehicle.

16. The driving intention indicating method of claim 13, further comprising:
providing a sensor configured to sense objects located in an edge of the indicating image on the road surface projected by the projection system; and
when an object is sensed by the sensor, generating a warning signal outside of the vehicle.

17. (canceled)

18. (canceled)

19. The driving intention indicating method of claim 13, further comprising controlling the projection system to project a lane change indicating image on a road surface close to a side of a changing lane direction of the vehicle according to a lane changing instruction.

20. The driving intention indicating method of claim 19, wherein the lane change indicating image comprises at least one of a lane changing symbol, a lane changing arrow film and a lane changing indicating text.

21. A driving intention indicating device, comprising:
a projection system arranged on a vehicle; and
a control unit configured to control the projection system according to a change in a gear position of a gearbox of the vehicle;
wherein when the gear position of the gearbox of the vehicle is switched from a first gear position to a second gear position, the control unit is configured to control the projection system to project an indicating image on a road surface close to the vehicle according to a moving direction of the second gear position, in order to indicate a moving direction of the vehicle from a parked position;
wherein the control unit is further configured to control the projection system to project a turn indicating image on a road surface close to a side of a turning direction of the vehicle according to a turning instruction.

22. The driving intention indicating device of claim 21, wherein the turn indicating image comprises at least one of a turning symbol, a turning arrow film and a turn indicating text; wherein the turning instruction is generated by at least one of a gesture input, a voice input, a touch input, a trigger signal of the turn signal lights and a trigger signal of a button.
